(19) United States
(12) Patent Application Publication
(10) Pub. No.: US 2023/0364988 A1
(43) Pub. Date: Nov. 16, 2023

(54) AUTOMOTIVE FUEL CAPLESS PLASTIC MOLDED COMPONENT INCORPORATING GRAPHENE

(71) Applicant: Martinrea International US Inc., Auburn Hills, MI (US)

(72) Inventors: Cory Doble, Ortonville, MI (US); Murali Chandrasekhar, Rochester, MI (US); Ryan Majewski, Grand Blanc, MI (US); Sorin Stancu, Dearborn, MI (US)

(21) Appl. No.: 18/143,184

(22) Filed: May 4, 2023

Related U.S. Application Data
(60) Provisional application No. 63/340,138, filed on May 10, 2022.

(51) Int. Cl. B60K 15/05

(52) U.S. Cl. CPC B60K 15/05; B60K 2015/0461

(57) ABSTRACT

A capless fuel unit having an elongated housing open at each end and defining a first and a second longitudinally spaced fluid ports. First and second door assemblies each include a flapper valve associated with a first fluid port and a second flapper valve with a second fluid port, the flapper valves being movable between open and closed positions and resiliently urged toward their respective closed positions. A pressure relief valve is at least partially contained within an interior of the flapper valves. The various plastic components of the capless unit incorporate Graphene or a Graphene-derivative for resisting hydrocarbon emission from fuel vapors escaping from the unit to the atmosphere.

### CROSS REFERENCE TO RELATED APPLICATIONS

The present application claims priority from U.S. Ser. No. 63/340,138 filed May 10, 2022.

### FIELD OF THE INVENTION

The present invention relates generally to plasticized molded materials utilized in hydrocarbon related applications in which permeation of the material is a concern. More specifically, the present invention discloses a combination polymer/Graphene composite material for limiting permeation of hydrocarbons, such as for use in various vehicle applications not limited to capless units, fuel caps in use in various types of refueling, fuel storage, vapor recovery or fuel delivery systems.

### BACKGROUND OF THE INVENTION

The automotive industry has been transitioning from metal materials to plastic materials over the past decades due to cost and desired reduction in weight. One of those areas that had seen much of the material conversion is in a vehicle fuel system along with the addition of ORVR (Onboard Refueling Vapor Recovery) systems. A downside to the use of plastic materials, in comparison to metal, is the hydrocarbon permeation of the plastic. Stringent government regulations related to increasing awareness of climate issues have led to demands of enhanced control of automotive fuel emissions. In the late 1990's, automotive suppliers in the United States were forced to start implementing ORVR systems to meet EPA requirements for reducing automotive hydrocarbon emissions. Using low permeation plastic materials is a key component to keep emissions down to meet governmental requirements.

Components made from plastic materials are also found in modern vehicle fuel systems, most commonly being some sort of Nylon, such as for use in any of a fuel pump thread rings, quick connectors, Fill Limit Vent Valves/Combo Valves, Inlet Check Valves, Fuel Caps, and Capless units. All of these components contribute and add up to the overall amount of a vehicle's hydrocarbon emissions, such as which is limited by government regulations. By adding Graphene into Nylon (PA/PPA) or other plastics such as Acetal (POM), the amount of hydrocarbons permeating through that material is reduced.

More specifically for plastics being used in a Capless refueling system, there are usually one or two doors along with an inner or outer body to contain the door assemblies. Additionally, there could be some sort of pressure relief valve that is designed to allow fuel vapor pressure to escape a fuel tank in severe conditions. These components are generally constructed out of Nylon or to reduce the amount of vapor emissions that are located inside of the fuel filler pipe after refueling or even under normal vehicle operating conditions.

As is also known, Graphene is a two-dimensional planar nanomaterial comprising of sp2 bonded carbon atoms packed in the honeycomb lattice. Many of the material properties, such as high tensile strength, high thermal and electrical conductivity, chemical and permeation resistance that makes Graphene lucrative stems from the unique bonding structure of the planar Graphene. However, the application of Graphene at a macroscopic scale for applications as in the automotive industry continues to be a challenge.

### SUMMARY OF THE INVENTION

The present invention describes use of Graphene polymer or copolymer composite system to provide premium quality automotive industry scale fluid transport tubing with improved mechanical and barrier properties. In particular, the present invention discloses the use of a Graphene-derivative incorporated into the plastic components of the capless unit associated with a fuel filler tube, in order to provide a premium quality automotive industry scale capless unit with improved mechanical and barrier properties. This further includes the incorporating of a Graphene-derivative into the plastic components of the capless unit and including, without limitation, each of a main cylindrical body, an end-most outer body, door assemblies and pressure relief valves.

In a non-limiting application, a capless fuel filling system includes an elongated tubular and cylindrical housing open at each end. Typically, the cylindrical housing is constructed from a plastic material for providing an inexpensive yet durable construction.

First and second axially spaced fluid ports are formed within the housing, with the first fluid port positioned adjacent the inlet of the housing and the second fluid port positioned adjacent the outlet for the housing. The fluid ports are substantially axially aligned with each other and are dimensioned to receive a standard fuel filling nozzle (not shown) therethrough. The design of the fluid ports in the capless unit is further such that insertion of an unauthorized hose (such as for siphoning theft of the gas held in the tank) is prevented.

Flapper valves are associated with each of the fluid ports and are movable between open and closed positions. A spring urges each of the valves towards the closed position. Both flapper valves move away from the housing inlet and towards the housing outlet when moving from a closed to an open position, such as in response to insertion of the fuel filler pipe or nozzle. In this fashion, the fuel filling nozzle inserted into the inlet end of the housing passes through both the first and second fluid ports and, in doing so, pivots the first and second flapper valves from an open position to a closed position.

The plastic components of the capless unit can include any of a thermoplastic, thermoset, elastomer or other natural or synthetic polymers or copolymers and may be chosen from, but not restricted to, any of a polypropylene, nylon 6, nylon-12, nylon-6,12, polyethylene, HDPE, terephthalate, polybutylene, polyvinyl fluoride, polyphthalamide, polyoxymethylene, polycarbonate, polyvinylchloride, polyester, and polyurethane.

As further depicted, the capless unit includes an arrangement of elastomeric seals, including pairs of each of outer annular body seals, along with inner annular door seals and pressure relief seals associated each of the first and second fluid ports.

Other envisioned applications of the present invention include the Graphene-derivative materials being incorporated into the plastic components associated with a quick connector device for a fuel system, such including a male connector defining a first body and a female connector defining a second body to which said male connector is engaged to define a fluid communicating passageway. An arrangement of elastomeric seals is incorporating within at least one of the bodies and, in combination with the Graphene/Graphene-derivative impregnated plastic components, resisting hydrocarbon emission from fuel vapors escaping from the unit to the atmosphere.

Additional variants include incorporating the Graphene-derivative material into a combination EVAP carbon canister body and cover, this including a plastic component associated with at least one of the canister body and cover incorporating the Graphene-derivative material for resisting hydrocarbon emissions from the fuel vapors escaping to the atmosphere.

In a further related application, an EVAP bleed emissions scrubber body and cover includes a body containing a sorbent material which is adsorptive of vaporized hydrocarbons for preventing bleed emissions. As with the canister variant, a plastic component of the body incorporates a Graphene-derivative component for resisting hydrocarbon emission from fuel vapors escaping to the atmosphere.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of a vehicle capless unit incorporating a Graphene-derivative into the various plastic components according to one non-limiting embodiment of the present invention;

FIG. 2 is a plan cutaway of the vehicle capless unit shown in FIG. 1 and depicting an internal arrangement of outer body, pressure relief valves, door assemblies and seals;

FIG. 3 is a further cutaway view similar to FIG. 2 and additionally depicting an arrangement of the plastic components for resisting hydrocarbon vapor emissions from exiting to the atmosphere;

FIG. 4 is an elevation view of a fluid quick connecter device according to a further embodiment of the present invention incorporating a Graphene-derivative into the various plastic components;

FIG. 5 is a cutaway view of the fluid connector device illustrating the tube with annular extending protuberance in an intermediate engaged position with a retainer latch;

FIG. 6 is a further succeeding plan cutaway view of the fluid connector device of FIGS. 4-5 and illustrating the tube installed through the latch and with the sides of a separate verifier held open by alignment with the annular bead representing the tube in an installed position;

FIG. 7 is a schematic of an overall evaporative emission control system utilizing an adsorbent material within an EVAP vapor canister incorporating a Graphene-derivative into the plastic body or lid components according to still further application of the present invention;

FIG. 8 is an illustration in partially exploded and plan cutaway of an EVAP canister body and lid, such as employed in the evaporative emission control system of FIG. 7, and depicting a first non-limiting variant in which Graphene-derivatives are incorporated into either or both the plastic body and lid, with a first fleece layer being located at a first end of the canister to which is attached load and purge lines, and a second fleece layer located at an opposite end of the canister in communication with a fresh air port; and

FIG. 9 is an illustration of a scrubber element connected to a canister via the canister vent port and having a honeycomb extruded structure including any combination of lignocellulose, charcoal, ceramic, binder, and flux material.

### DETAILED DESCRIPTION OF THE PREFERRED EMBODIMENTS

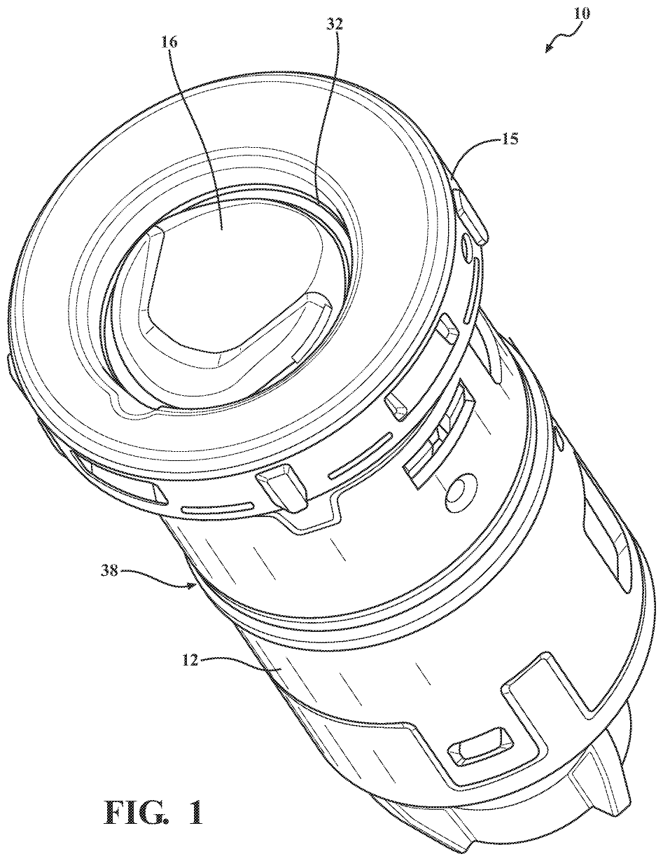

With reference to the attached illustrations, the present invention discloses a capless fuel unit or assembly, such as which incorporates an arrangement of plastic components integrating a Graphene-derivative. Specifically, FIG. 1 provides a perspective view of a vehicle capless unit, generally at 10, incorporating an arrangement of plastic components incorporating a Graphene-derivate according to one non-limiting embodiment of the present invention.

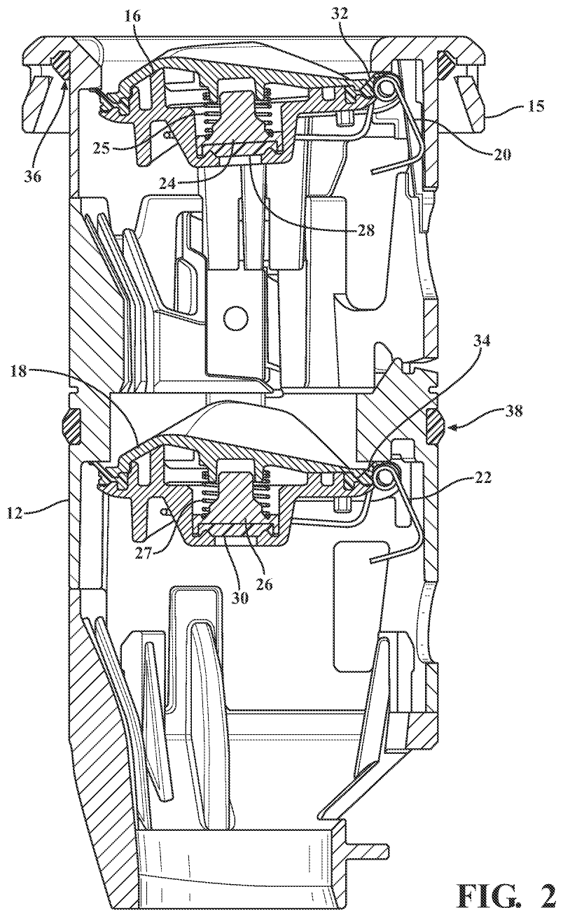

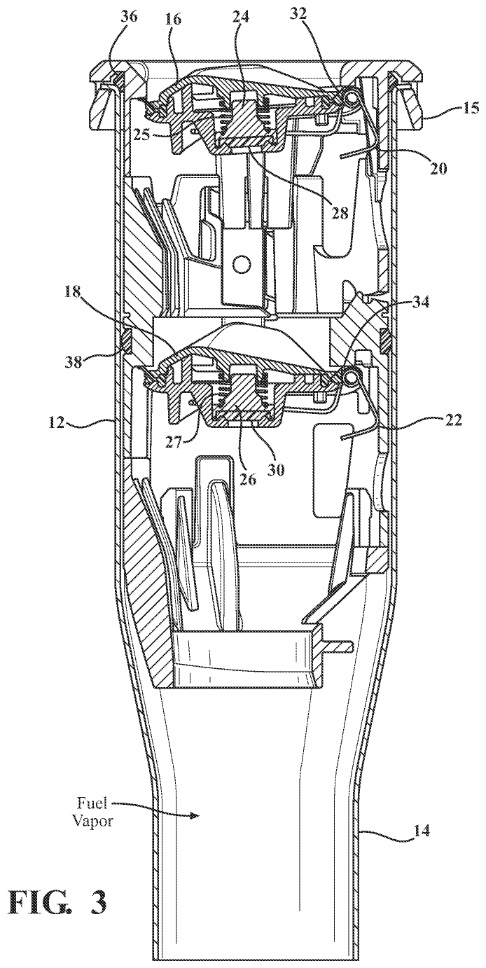

FIG. 2 further provides is a plan cutaway of the vehicle capless unit shown in FIG. 1 and depicts an internal arrangement of each of an outer body, first and second pressure relief valves, door assemblies and seals. FIG. 3 depicts a further cutaway view similar to FIG. 2 and additionally depicting an arrangement of the plastic components incorporating a Graphene-derivative for resisting hydrocarbon vapor emissions from existing to the atmosphere.

With reference again to illustrations viewed collectively, an elongated tubular and cylindrical outer body housing 12, such having a plastic, polymer or copolymer construction and not limited to Nylon, is shown and which is open at each end. The housing 12 is, in the illustrated embodiment, incorporated into a fuel filler tube 14 (see FIG. 3) such that it is exposed to the presence of hydrocarbon fuel vapors emanating from the connected fuel tank (not shown). As further shown, a separate outermost body portion 15 is provided and which, upon assembly to an upper end of the main housing 12, defines an inlet for the fuel filler tube or hose 14.

As further shown, the housing defines first and second longitudinally spaced fluid ports, which correspond with the location of each of first 16 and second 18 flapper valves (again FIGS. 2-3), these being movable between open and closed positions. In one non-limiting configuration, each of the first 16 and second 18 flapper valves respectively incorporate first and second valve parts secured together by a snap fitting. Also depicted are a pair of springs 20 and 22 which resiliently urge the flapper valves 16/18 toward their respective closed positions.

Also depicted in each of FIGS. 2-3 are first 24 and second 26 pressure relief valves corresponding to the first 16 and second 18 flapper valves and are further biased open by corresponding coil springs 25 and 27. As shown, the pressure relief valves are shown contained within an interior of the flapper valves 16/18.

The present invention further depicts an arrangement of elastomeric seals positioned within the housing in proximity with the flapper valves for sealing the hydrocarbon fuel and vapors within the fill pipe and capless to prevent them from escaping into the atmosphere. As depicted, these include each of first 28 and second 30 pressure relief seals located at the pressure relief valves 24/26.

Also included are first 32 and second 34 elastomeric door seals corresponding in placement along with the first 16 and second 18 flapper valves. Additional body seals are depicted at 36 (corresponding to outer body portion 15) and 38 (at a further intermediate location along the main cylindrical housing 12) configured at axial spaced locations.

The incorporating of a Graphene-derivative material into the plastic components, such as again in particular each of the main cylindrical housing 12, upper end outer body 15, pressure relief valves 24/26 and door assemblies/flapper valves 16/18, operates to resist permeation of hydrocarbon vapor emissions exiting to the atmosphere.

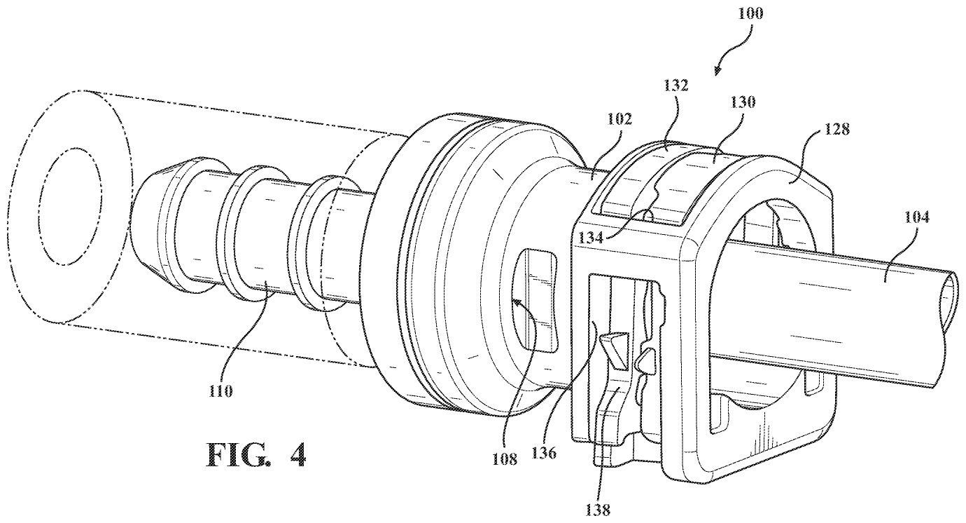

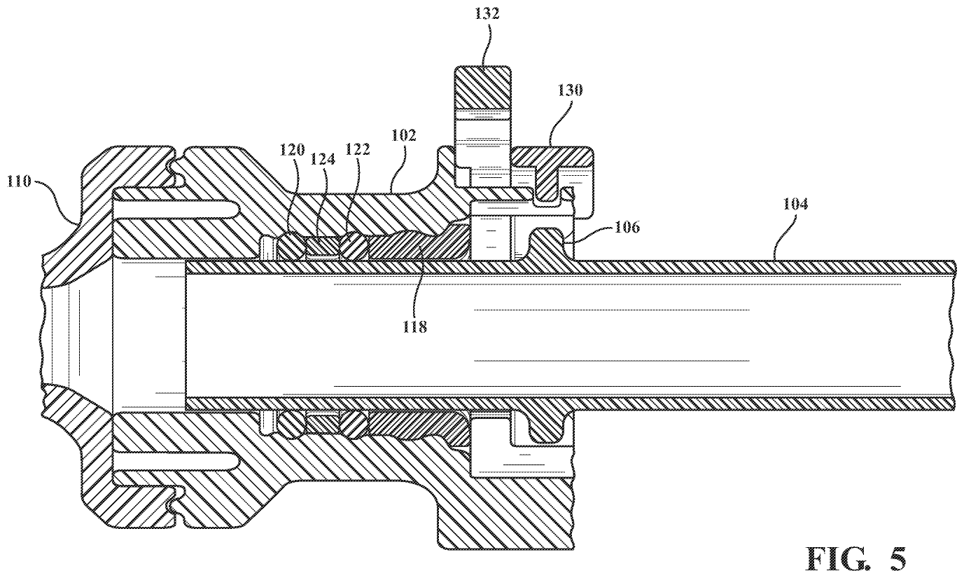

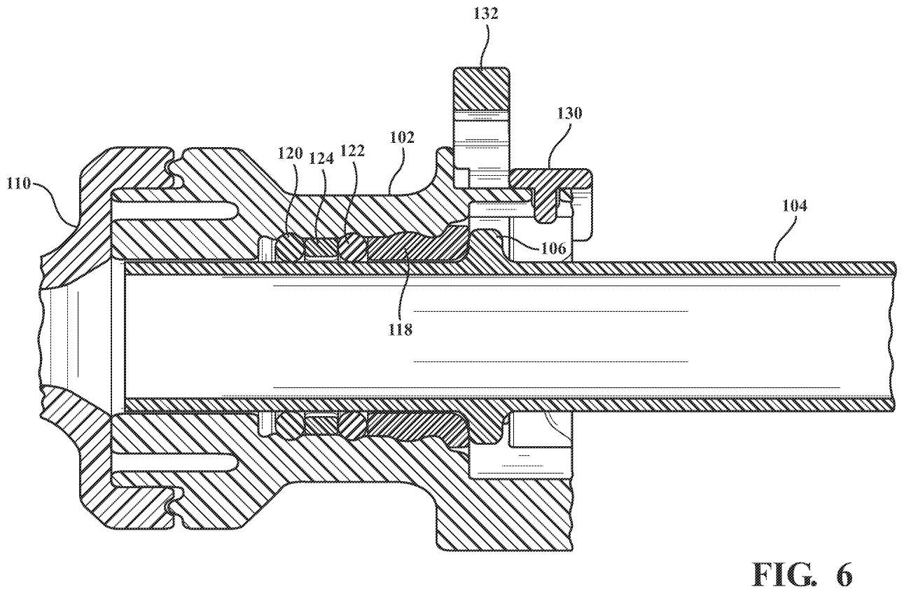

Referring to FIG. 4, an elevation view is shown at 100 of the fluid coupling according to a further embodiment of the present invention and in which some or all of the plastic components incorporate a Graphene-derivative material. The coupling has a housing 102 with a female part and an interconnected insertion tube 104. The tube 104 also includes a radially outwardly extending bead 106 (see subsequent FIGS. 5-6) adjacent its end which extends around the circumference of the cylindrical tube 104.

The housing female part 102 incorporates a throughbore 108 which communicates the female part with a connected male part 110, the throughbore receiving the tube 104 having the annular extending bead 106. Without limitation, the female part 102 and male part 110 of the quick connect housing can be constructed of a suitable material typically including a plastic incorporating the Graphene-derivative, and it is further envisioned that a further hose or conduit (not shown) is secured over the narrowed diameter male part 110 so that the throughbore communicates the installed tube 104 with the outlet of the male part 110.

A heat staking operation is employed for securing a tubular outer spacer 118 within the housing female part in proximity to the receiving end of the tube 104 and annular bead 106. The spacer 118 is provided in combination with an arrangement of seals 120 and 122 and interposed annular support 124 compressed between the outer spacer 118 and an inward annular shoulder location 126 for providing pressurized sealing support between the female 102 and male 110 portions of the housing.

Without limitation, the heat staking operation can be provided according to any plurality and angular offset, such as including but not limited to placing the heat stake locations at 60 degree offset (total of six), as well as providing any other shape or profile. In any application, the heat staking operation ensures that the outer spacer is retained within the body head and avoids instances of axial separation, such as following detached separation of the tube and bead in the manner subsequently described.

The female housing part 102 further integrates an insertion end 128 (this being shown in cutaway in the remaining views) having an outline corresponding to each of a latch 130 and verifier 132. The latch and verifier are constructed of a similar plastic and resilient material which, along with the female 102 and male 110 parts, can likewise incorporate a Graphene-derivative material, and are provided in a stacked arrangement and installed within the female part 102 in communication with the inserting direction of the tube 104 through the interior throughbore 108, these further being arranged in a stacked arrangement and supported within the end 128 through a top located installation slot (see inner extending edge profile 134). The insertion end 128 further exhibits opposite side cutout profiles, one of which is illustrated by perimeter edge 136 in FIG. 1 for seating extending pairs of extending sides or legs of each of the latch 130 and verifier 132, and such that the latch and verifier each exhibit a generally “U” shape surrounding on three sides the cross sectional profile of the inserted tube 14.

Insertion of the tube 104 results in a pair of downwardly extending sides associated with each of the latch 30 expanding outwardly and likewise expanding similarly directed and extending sides of the verifier 132 (one of these sides further depicted at 138 in FIG. 4). Upon passage of the tube supported bead 106 past the latch 130, the latch seats in the engaged position, with the verifier 132 held open by alignment with the annular bead 106. The verifier is subsequently displaced (downwardly) to a fully engaged position to lock the latch engagement and to indicate that the fluid coupling is fluidly connected.

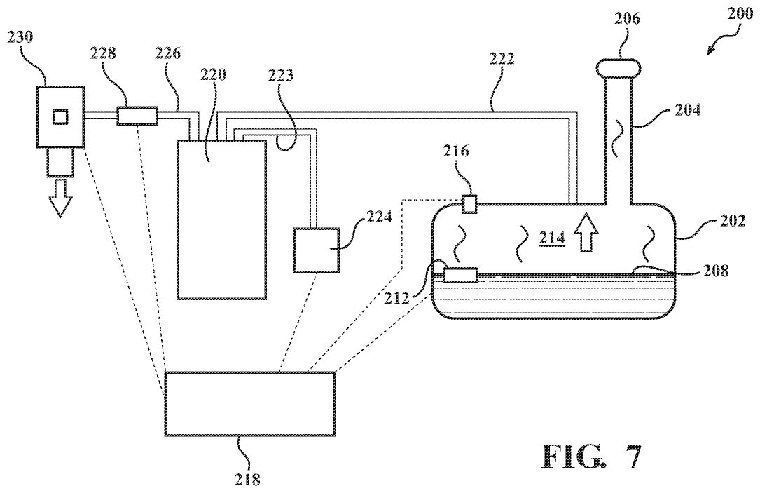

Referring now to FIG. 7, a schematic of an evaporative emission control system, generally referenced 200, is shown according to a further embodiment of the invention utilizing a sorbent material which is capable of adsorbing hydrocarbons. The system includes a fuel tank 202 with an extending fill neck 204 and a sealed fuel cap or capless 206. The fuel tank is shown in cutaway and depicts liquid gasoline defining a fill level 208 which is read by a fuel level sensor 212. Above the fill level, an unoccupied upper expansion space or volume of the tank is occupied by fuel vapors 214 (e.g. pentanes, butanes, etc.). A fuel tank pressure sensor 216 is also located in the tank 202 and, in combination with the fuel level sensor 212, supplies fill level and tank pressure readings to a suitable Powertrain Control Module (PCM) 218.

An EVAP vapor canister 220 is provided and is communicated by a vapor inlet line 222 extending from the fuel tank 202, this communicating with a vent control valve for allowing the flow of fuel vapors from the fuel tank into the EVAP canister 220. An EVAP vent 223 extending from the canister 220 includes a normally open EVAP solenoid valve 224. A further line 226 extends from the canister 220 to a purge flow sensor 228 to an EVAP purge sensor (typically closed) 230 which is connected to an air induction system and allows the engine intake vacuum to siphon (desorb) precise amounts of fuel vapors previously adsorbed within the EVAP canister for delivery into the engine intake manifold and eventual combustion. The PCM module 218 also receives inputs from each of the EVAP vent solenoid 224, purge flow sensor 228 and EVAP purge solenoid 230.

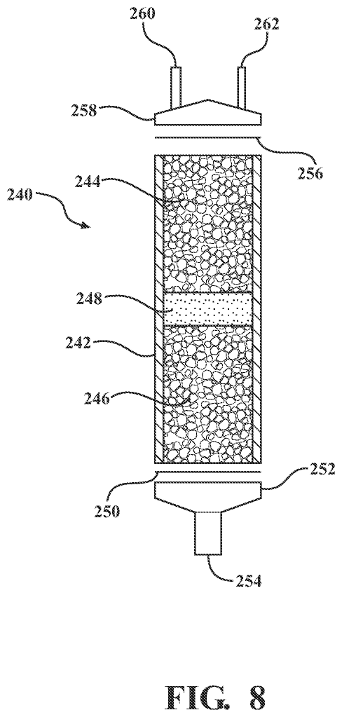

Proceeding to FIG. 8, an illustration is generally shown at 240 in partially exploded and plan cutaway of an EVAP canister, such as employed in the evaporative emission control system of FIG. 7 in which the canister is depicted again at 220. The EVAP canister includes a main housing 242 (also shown in non-limited fashion having a cylindrical shape with a hollow interior), a bottom cover 252, and a top cover 258 that are constructed of a suitable material typically including a plastic incorporating a Graphene-derivative. While a linear canister is depicted in FIG. 8, it is further understood that any configuration of canister, including non-linear, is envisioned within the scope of the invention.

The housing 242 encloses a volume of the adsorbent material capable of adsorbing hydrocarbon vapors. The adsorbent material is depicted as upper 244 and lower 246 sections, these separated by a compression device 248 used to maintain the canister volume and enable proper adsorption of fuel vapors in the canister.

A first fleece layer 250 is located at one end of the canister main housing 242 and over which is attached a top cover 252 incorporating a fresh air port 254. A second fleece layer 256 is located at an opposite end of the canister main body 242 and over which is attached a further cover 258 incorporating each of load 260 and purge 262 lines, the felt layers being provided in each embodiment for assisting in packing down the sorbent material within the canister.

The operation of the EVAP canister 240 is similar as that previously described and includes the vapor canister being communicated by the vapor inlet (load) line 260 extending from the fuel tank, again communicating with a vent control valve for allowing the flow of fuel vapors from the fuel tank into the EVAP canister. The EVAP vent (also air port 254) extends from the canister 240 and includes a normally open EVAP solenoid valve (see again at 224 in FIG. 7), with the further line 262 extending from the canister 240 to the purge flow sensor (previously at 228 as described in FIG. 1) to the EVAP purge sensor 230 (typically closed) which is connected to an air induction system and allows the engine intake vacuum to siphon (desorb) precise amounts of fuel vapors previously adsorbed within the EVAP canister for delivery into the engine intake manifold during operation of the engine and eventual combustion.

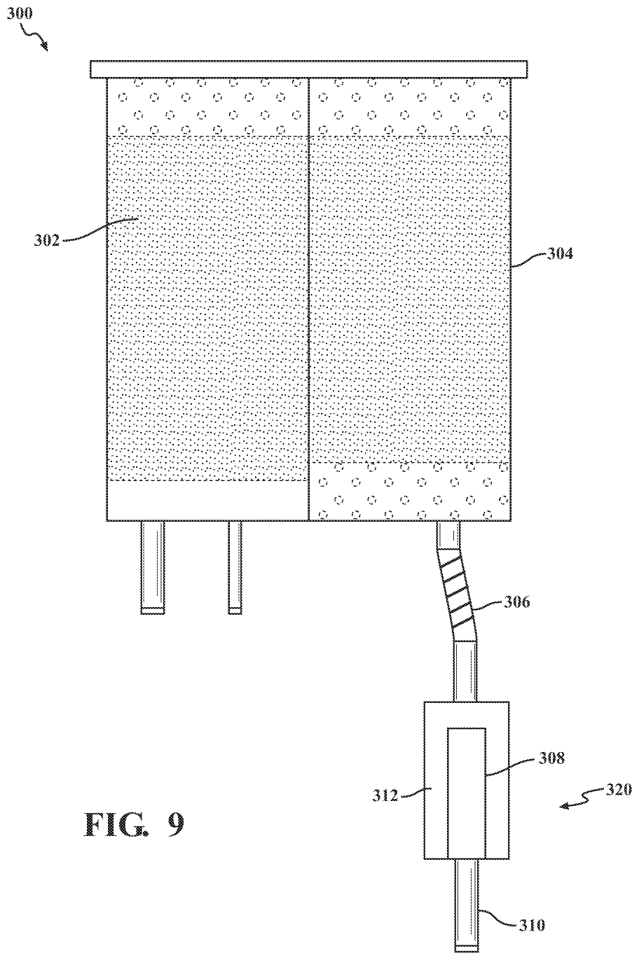

Finally, FIG. 9 presents a further cutaway illustration, generally at 300 of a modified EVAP canister, such as previously depicted, and which can be filled with an activated carbon material 302, with a surrounding main canister plastic body 304. As shown, the canister further illustrates the various chambers associated with the adsorption process for drawing the hydrocarbon vapors from the fuel tank through the vent line, along with a separate purge port for desorbing the retained hydrocarbons to the engine intake manifold during combustion.

Also depicted in FIG. 9 is a scrubber 320 which can be either incorporated into the canister housing 304 or, as shown, depicted as separate but connected to the canister 300 by a line 306. The scrubber construction consists of but is not limited to a housing 312 with a port that connects to the canister 300 by the line 306. A cover 310 with a fresh airline port, and a scrubber element 308 contained within the scrubber canister 320, with grommets to protect the scrubber element (not shown). The scrubber 308 interior exhibits a honeycomb extruded structure including any combination of activated lignocellulose, charcoal, ceramic, binder, and flux material. The cover 310 and housing 312 for the scrubber as described herein can, similar to the main canister 304 and as is separately shown in FIG. 8, is also be constructed of a plastic with a Graphene-derivative material.

Without limitation as to any of the distinct embodiments previously described in each of FIGS. 1-3, 4-6, 8 and 9, the group of Graphene-derivatives may again include, but are not limited to, any of a Graphene, monolayer Graphene, few layered Graphene, Graphene oxide, reduced Graphene oxide, and functionalized Graphene. The loading concentration of Graphene-derivatives may vary from 0.1-50 percentage by weight. The polymer or copolymer may include any of a thermoplastic polymer and may be chosen from, but not restricted to polyurethane, polyester, polypropylene, nylon 6, nylon 6,6, nylon-12, nylon-6,12, polyethylene, terephthalate, polybutylene, polyphthalamide, polyoxymethylene, polycarbonate and polyvinylcyhloride.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A capless fuel unit constructed of plastic components and comprising:
an elongated housing open at each end;
at least one flapper valve associated with a fluid port contained within said housing and movable between open and closed positions, said flapper valve being resiliently urged to the closed position; and
an arrangement of elastomeric seals positioned within said housing in proximity with said flapper valve; and
at least one or more of the plastic components incorporating a Graphene-derivative for resisting hydrocarbon emission from fuel vapors escaping from the unit to the atmosphere.

2. The apparatus of claim 1, said at least one flapper valve further comprising a first flapper valve associated with a first fluid port and a second flapper valve associated with a second longitudinally spaced fluid port.

3. The apparatus of claim 2, further comprising a pressure relief valve contained within an interior of each of said flapper valves.

4. The apparatus of claim 1, further comprising an outer body attachable to said housing.

5. The apparatus of claim 1, the plastic components further comprising at least one of a thermoplastic, thermoset, elastomer or other natural or synthetic polymers and may be chosen from, but not restricted to, any of a polypropylene, nylon 6, nylon-12, nylon-6,12, polyethylene, HDPE, terephthalate, polybutylene, polyvinyl fluoride, polyphthalamide, polyoxymethylene, polycarbonate, polyvinylchloride, polyester, and polyurethane.

6. The unit of claim 1, further comprising a spring urging each of said flapper valves towards a closed position.

7. The apparatus as defined in claim 1, said elastomeric seals further comprising door seals surrounding said flapper valves.

8. The apparatus as defined in claim 1, said elastomeric seals further comprising body seals configured into first and second axial spaced locations of said housing.

9. The apparatus of claim 1, said Graphene-derivative further comprising at least one selected from a group including Graphene, monolayer Graphene, few layered Graphene, Graphene oxide, reduced Graphene oxide, and functionalized Graphene.

10. The apparatus as defined in claim 2, each of said first and second flapper valves further comprising first and second valve parts secured together by a snap fitting.

11. A capless fuel unit constructed of plastic components and comprising:
an elongated cylindrical housing open at each end, said housing defining a first and a second longitudinally spaced fluid ports,
a first flapper valve associated with said first fluid port and a second flapper valve associated with said second fluid port, said flapper valves being resiliently urged by first and second springs from an open position to a closed position;
a pressure relief valve contained within an interior of each of said flapper valves; and
an arrangement of elastomeric seals positioned within said housing in proximity with said flapper valves; and
at least one or more of the plastic components incorporating a Graphene or Graphene-derivative for resisting hydrocarbon emission from fuel vapors escaping from the unit to the atmosphere.

12. The apparatus as defined in claim 11, said elastomeric seals further comprising door seals surrounding said flapper valves.

13. The apparatus as defined in claim 11, said elastomeric seals further comprising body seals configured into first and second axial spaced locations of said cylindrical housing.

14. The apparatus as defined in claim 11, each of said first and second flapper valves further comprising first and second valve parts secured together by a snap fitting.

15. The apparatus of claim 11, said Graphene-derivative further comprising at least one selected from a group including Graphene, monolayer Graphene, few layered Graphene, Graphene oxide, reduced Graphene oxide, and functionalized Graphene

16. A quick connector device for a fuel system, comprising:
a male connector defining a first body and a female connector defining a second body to which said male connector is engaged to define a fluid communicating passageway;
an arrangement of elastomeric seals incorporating within at least one of said bodies; and
at least one or more of the plastic components incorporating a Graphene-derivative for resisting hydrocarbon emission from fuel vapors escaping from the unit to the atmosphere.

17. The device of claim 16, said Graphene-derivative further comprising at least one selected from a group including Graphene, monolayer Graphene, few layered Graphene, Graphene oxide, reduced Graphene oxide, and functionalized Graphene.

18. The device of claim 16, the plastic components further comprising at least one of a thermoplastic, thermoset, elastomer or other natural or synthetic polymers and may be chosen from, but not restricted to, any of a polypropylene, nylon 6, nylon-12, nylon-6,12, polyethylene, HDPE, terephthalate, polybutylene, polyvinyl fluoride, polyphthalamide, polyoxymethylene, polycarbonate, polyvinylchloride, polyester, and polyurethane.

19. A combination EVAP carbon canister body and cover, comprising a plastic component of said canister body and/or said cover incorporating a Graphene-derivative for resisting hydrocarbon emission from fuel vapors escaping to the atmosphere.

20. The body and cover of claim 19, said Graphene-derivative further comprising at least one selected from a group including monolayer Graphene, few layered Graphene, Graphene oxide, reduced Graphene oxide, and functionalized Graphene.

21. The body and cover of claim 19, the plastic components further comprising at least one of a thermoplastic, thermoset, elastomer or other natural or synthetic polymers and may be chosen from, but not restricted to, any of a polypropylene, nylon 6, nylon-12, nylon-6,12, polyethylene, HDPE, terephthalate, polybutylene, polyvinyl fluoride, polyphthalamide, polyoxymethylene, polycarbonate, polyvinylchloride, polyester, and polyurethane.

22. An EVAP bleed emissions scrubber body and cover, comprising:
a plastic component of said body incorporating a Graphene-derivative for resisting hydrocarbon emission from fuel vapors escaping to the atmosphere.

23. The body and cover of claim 22, said Graphene-derivative further comprising at least one selected from a group including monolayer Graphene, few layered Graphene, Graphene oxide, reduced Graphene oxide, and functionalized Graphene.

24. The body and cover of claim 22, the plastic components further comprising at least one of a thermoplastic, thermoset, elastomer or other natural or synthetic polymers and may be chosen from, but not restricted to, any of a polypropylene, nylon 6, nylon-12, nylon-6,12, polyethylene, HDPE, terephthalate, polybutylene, polyvinyl fluoride, polyphthalamide, polyoxymethylene, polycarbonate, polyvinylchloride, polyester, and polyurethane.
